(19) United States
(12) Patent Application Publication
(10) Pub. No.: US 2009/0256032 A1
(43) Pub. Date: Oct. 15, 2009

(54) Device for Vibration-Damping Fastening of at Least One Object to a Support Element

(75) Inventors: Yasuki Takenaka, Fujisawa-City (JP); Norio Yokoo, Atsugi-City (JP)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 11/995,235

(22) PCT Filed: Jul. 6, 2006
(86) PCT No.: PCT/EP2006/006589

§ 371 Date: Apr. 14, 2008

(30) Foreign Application Priority Data
Jul. 12, 2005 (DE) 102005032535.1

(51) Int. Cl. F16L 3/22

(52) U.S. Cl. 248/68.1

(57) ABSTRACT

In devices for fastening at least one object (3) to a support element (8), an engaging arrangement (6) or a fastening arrangement is present by means of which a connection to said support element (8) can be realized. The engaging arrangement (6) or fastening arrangement is mounted on an inner cage (5) that is connected via a number of straight linking parts (15, 16, 17, 18) to an outer cage (4), on which in turn is formed a holding arrangement (1) for the or each object (3). Good decoupling of the holding arrangement (1) from the support element (8) with respect to mechanical vibration is thereby achieved.

### BACKGROUND OF THE INVENTION

1. Field of the Invention

The invention relates to a device for vibration-damping fastening of at least one object to a support element.

2. Description of the Related Art

Known from US 2004/0144897 A1 is a device comprising both an engaging arrangement mounted on an inner cage and a fastening arrangement that stands connected to an outer cage, the inner cage is connected to the outer cage via a linking part in the form of a circumferential brim.

Known from EP 1 030 095 A2 is an elastic suspension for vibrating components, which is implemented in the form of an annular, closed retaining loop that surrounds two retaining eyes provided to receive hooks. The two retaining eyes are each connected to the retaining loop via elastomeric webs designed for mutually different vibration damping, such that the component is largely vibrationally decoupled from the support element.

Known from DE 196 34 309 A1 is a device for fastening at least one elongated object to a support element, comprising an engaging arrangement that can be brought into engagement with the fastening bolt. The engaging arrangement is surrounded by an outer cage on which is mounted a holding arrangement for objects to be fastened, particularly conveying lines.

### SUMMARY OF THE INVENTION

The present invention provides a device of the initially cited kind, with which good decoupling with respect to mechanical vibrations is obtained between the support element and the or each elongated object, accompanied by stable fastening of the device to the support element.

By virtue of the fact that the engaging arrangement or fastening arrangement is mounted on an inner cage and the inner cage is connected to the outer cage via straight linking parts, efficient vibrational decoupling between the inner cage and the outer cage is brought about by the vibration-damping effect of the linking parts, and is accompanied by stable fastening of the device to the support element.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of an exemplary embodiment of a device according to the invention, with conveying lines, as the objects to be fastened, inserted in a holding arrangement;

FIG. 2 is a sectional view of a detail of the exemplary embodiment according to FIG. I in the region of an inner cage and an outer cage, with a fastening bolt to effect connection to a support element;

FIG. 3 shows section III-III from FIG. 2;

FIG. 4 shows section IV-IV from FIG. 2;

FIG. 5 shows section V-V from FIG. 2;

FIG. 6 shows section VI-VI from FIG. 2; and

FIG. 7 is a detail section of a further exemplary embodiment of a device according to the invention, with a fastening arrangement formed by a snap-in foot to effect connection to a support element.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

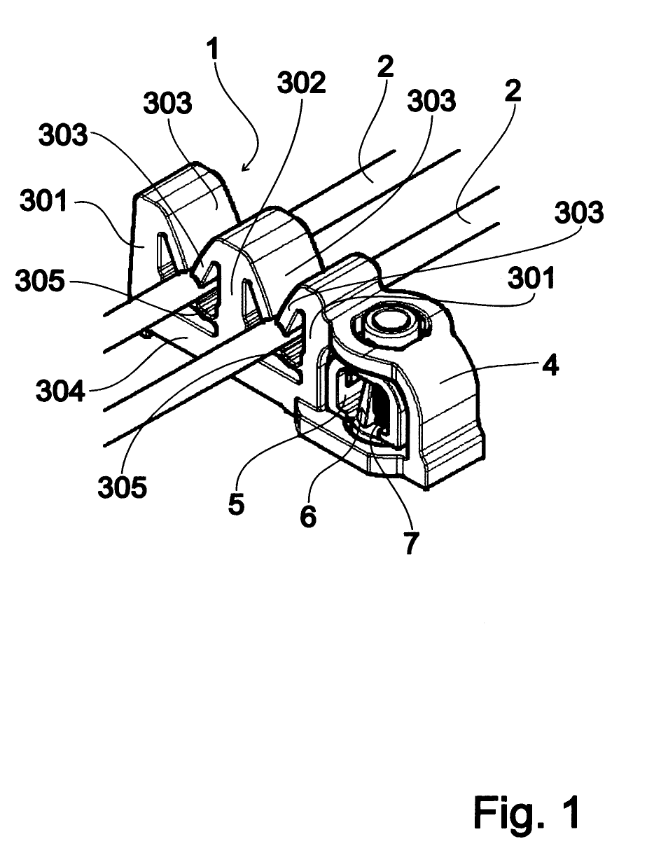

FIG. 1 is a perspective view of an exemplary embodiment of a device according to the invention, comprising a holding arrangement 1 in which preferably elongated objects, for example two conveying lines 2 in the form of electrical lines or fluid lines, can be fastened.

The conveying lines 2 are held in place by, inter alia, obliquely converging pivoting flaps 303 that are attached by one side to a respective one of lateral webs 301 or to an intermediate web 302, and by elastically damping bridge webs 305 disposed opposite the free ends of said pivoting flaps 303 and extending across between intermediate web 302 and the lateral webs 301 in spaced relation to a base plate 304.

The holding arrangement 1 stands connected to an outer cage 4 surrounding an inner cage 5. Outer cage 4 and inner cage 5 are spaced apart from each other. Inner cage 5, in turn, stands connected to an engaging arrangement 6, which in the representation according to FIG. 1 is engaged with a fastening bolt 7 mounted on a support element not illustrated in FIG. 1.

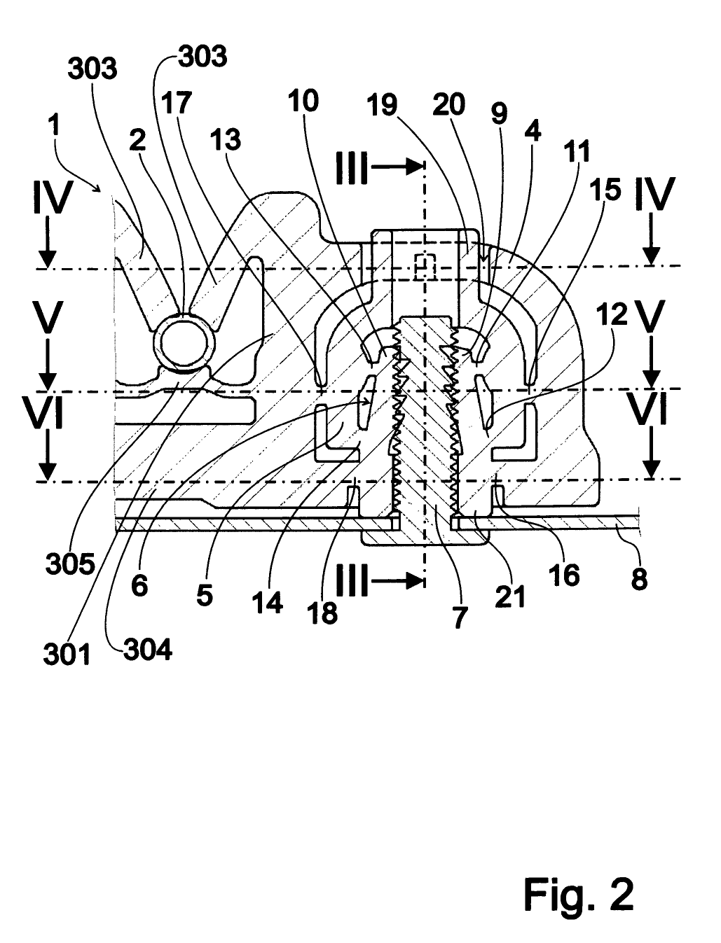

FIG. 2 shows the exemplary embodiment according to FIG. 1 in a longitudinal section, in which the sectional plane is at right angles to the longitudinal direction of the conveying lines 2. It can be seen from FIG. 2 that the fastening bolt 7 is implemented in the form of a threaded bolt that engages penetratingly through the support element 8, now depicted in FIG. 2. The engaging arrangement 6 comprises a first bolt claw 9 and a second bolt claw 10, which in the mated arrangement according to FIG. 2 lie laterally against the fastening bolt 7 and come into engagement with the fastening bolt 7 via an inwardly configured snap structure composed of elevations and depressions. The bolt claws 9, 10 are connected to inner cage 5 via endwise-disposed linking ribs 11, 12, 13, 14.

It can be seen from FIG. 2 that inner cage 5 is connected in turn, by its portion disposed inside outer cage 4, to outer cage 4 via straight linking parts 15, 16, 17, 18, which are four in number in the exemplary embodiment shown. It can also be understood from FIG. 2 that inner cage 5 comprises a substantially hollow-cylindrical cage neck 19, disposed rearwardly in the mating direction, which engages penetratingly through a neck opening 20 configured in outer cage 4 and in this exemplary embodiment protrudes slightly beyond the outer side of outer cage 4. The cage neck 19 serves to receive fastening bolts 7 that are relatively long in comparison to the dimensions of inner cage 5.

On the front side in the insertion direction of fastening bolt 7, inner cage 5 also protrudes, by a cage support 21, beyond outer cage 4, such that when the inventive device is fully mated with fastening bolt 7, inner cage 5 rests against support element 8, while outer cage 4 is spaced apart from support element 8. For decoupling purposes, therefore, vibrations are first conducted from support element 8 into inner cage 5.

It can be understood from FIG. 2 that opposite the free ends of pivoting flaps 303, the bridge webs 305 bulge forward in the direction of said pivoting flaps 303 and comprise a receiving saddle adapted to the outer contour of the conducting lines 2, to produce very good damping behavior in addition to secure seating. It should be noted in this connection that in the presence of excessive vibrations, inner cage 5 butts against outer cage 4, particularly via corner regions as defined regions of interaction, to prevent excessive vibration transmission with overloading of the linking ribs 11, 12, 13, 14, any shocks that may occur under these circumstances being readily absorbable due to the good damping behavior attributable to the configuration of the bridge webs 305.

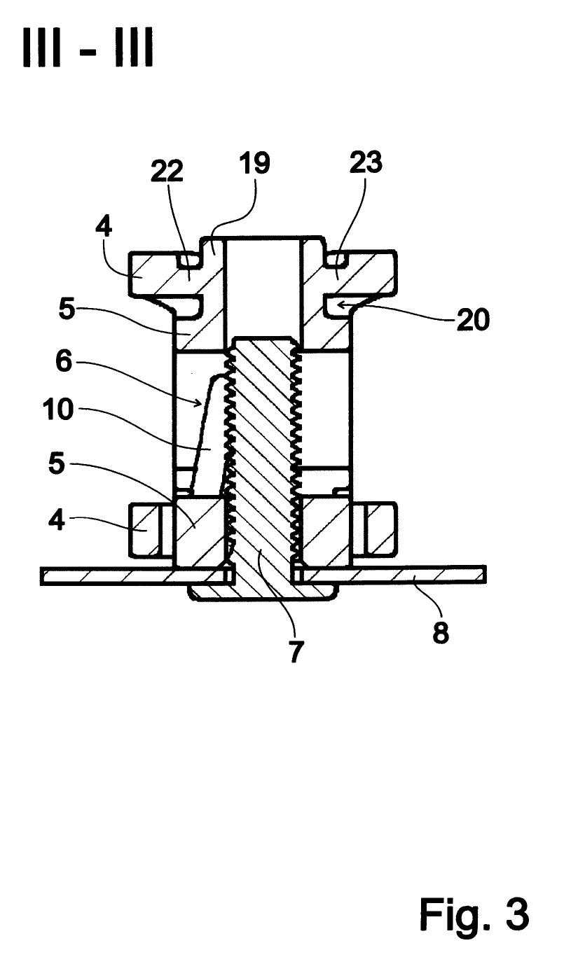

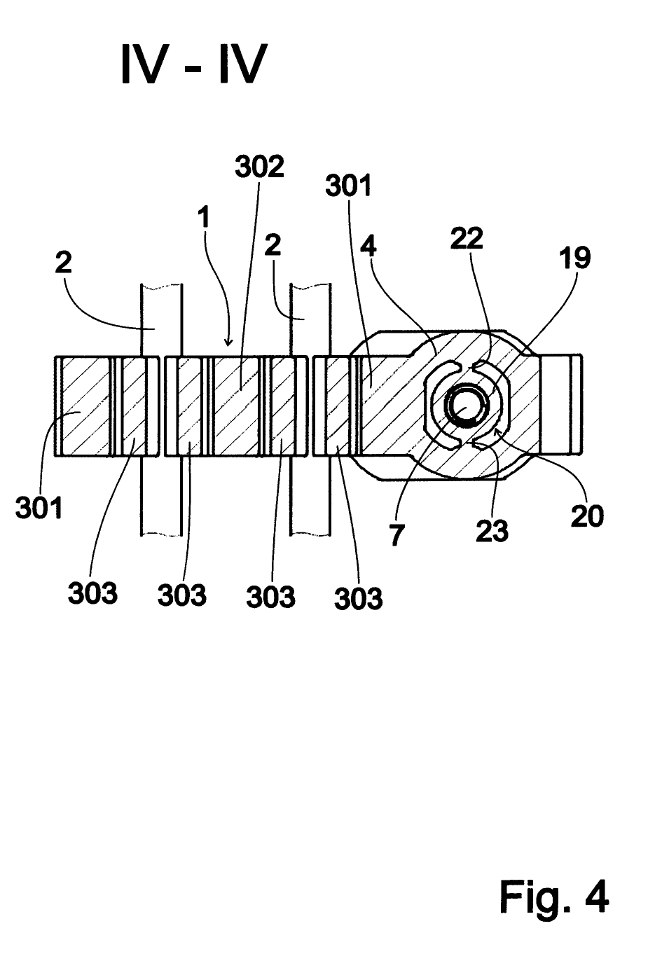

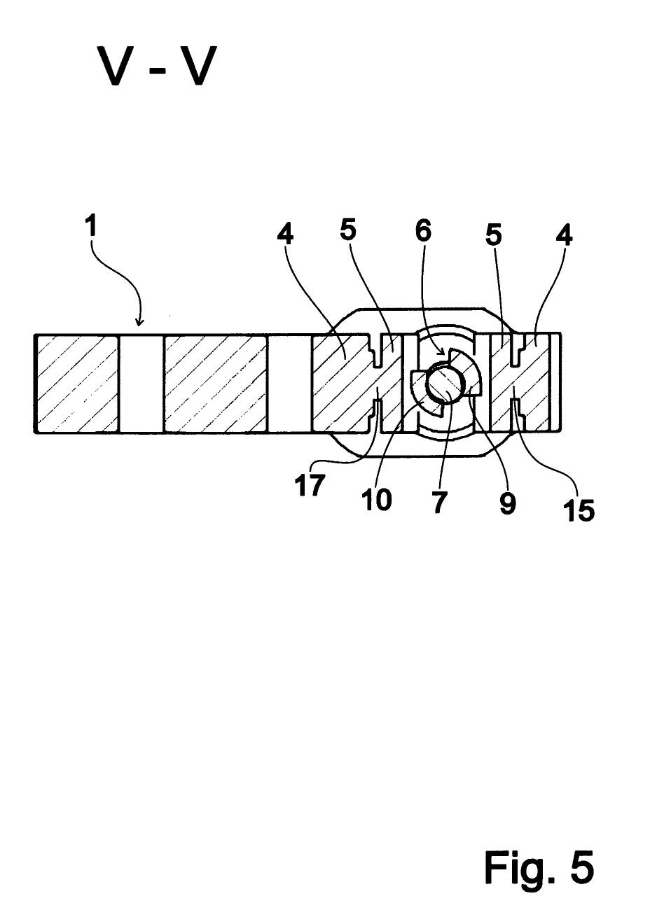

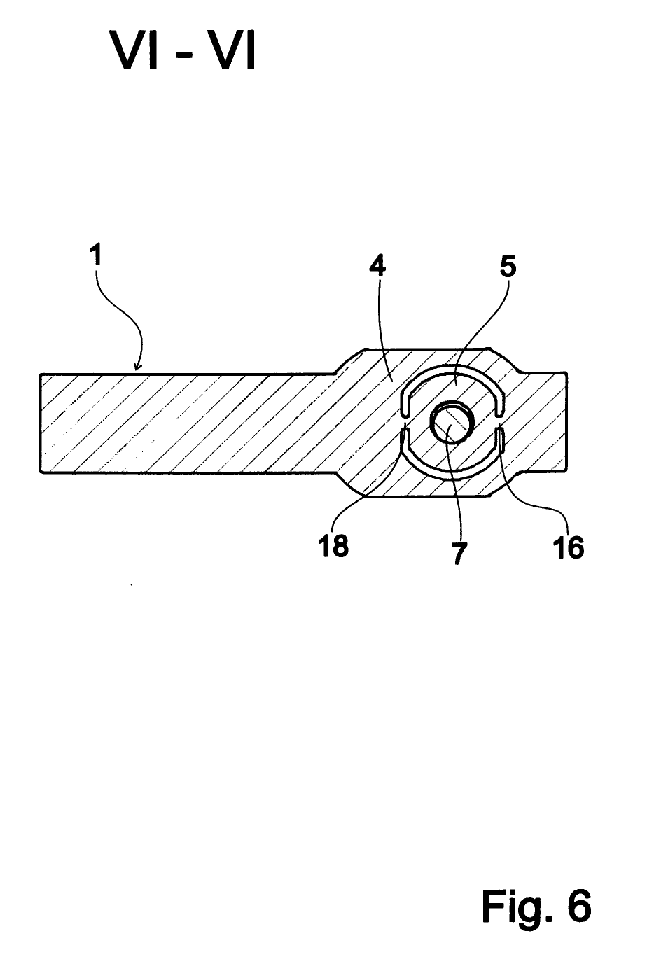

Further depicted in FIG. 2 are the positions of sections III-III, IV-IV, V-V and VI-VI, which are explained hereinafter with reference to FIG. 3, FIG. 4, FIG. 5 and FIG. 6, respectively.

FIG. 3 shows section III-III from FIG. 2. It can be seen from FIG. 3 that cage neck 19 is also connected to outer cage 4 via two straight linking parts 22, 23 crossing the neck opening 20.

FIG. 4 shows section IV-IV from FIG. 2. This section makes it clear that in the exemplary embodiment shown, the two linking parts 22, 23 mounted on the cage neck 19 are disposed diametrically opposite each other and the line connecting them extends in a first direction that is parallel to the longitudinal direction of the conducting lines 2, 3.

FIG. 5 shows section V-V from FIG. 2. It is clear from FIG. 5, for one thing, that the bolt claws 9, 10 are disposed diametrically opposite each other and that each extends over a circumferential angle of about 90 degrees. It can also be seen from FIG. 5 that connecting parts 15, 17 disposed between outer cage 4 and inner cage 5 in the central region in the longitudinal direction of the bolt 7 are arranged diametrically opposite each other, analogously to connecting parts 22, 23 mounted on cage neck 19, but lie on a connecting line that is oriented approximately at right angles to the connecting line between connecting parts 22, 23 mounted on cage neck 19. It is further depicted in FIG. 5 that connecting parts 15, 17 disposed in the central region are implemented with larger dimensions in the plane of section V-V than the dimensions of linking parts 22, 23 disposed in the region of neck portion 19.

FIG. 6 shows section VI-VI from FIG. 2. It can be seen from FIG. 6 that linking parts 16, 18, which are disposed in the bottom region of the inventive device and forwardly in the insertion direction of fastening bolt 7, are also arranged diametrically opposite each other, analogously to the previously described linking parts 15, 17, 22, 23, it being the case here that the connecting line between linking parts 16, 18 disposed in the bottom region extends in the same direction as the connecting line between linking parts 15, 17 disposed in the central region. It can further be appreciated from FIG. 6 that analogously to connecting parts 22, 23 mounted on cage neck 19, linking parts 16, 18 disposed in the base region have dimensions in the plane of section VI-VI that are smaller than the corresponding dimensions of linking parts 15, 17 disposed in the central region.

The dimensioning of the linking parts 15, 16, 17, 18, 22, 23 therefore produces the effect that the linking is implemented as strongest mechanically in the central region of outer cage 4 and inner cage 5, with the result that in the end regions, outer cage 4 is relatively mobile in comparison to inner cage 5 and is particularly markedly decoupled there from inner cage 5 with respect to vibrations, while the linking parts 15, 17 disposed in the central region create the most mechanically stable, but a less markedly vibrationally decoupled connection between outer cage 4 and inner cage 5, and thus between neck portion 19 and carrier element 8.

To achieve particularly good vibration damping, the device according to the invention is usefully made of a foamed synthetic material, preferably of PP/EPDM copolymer.

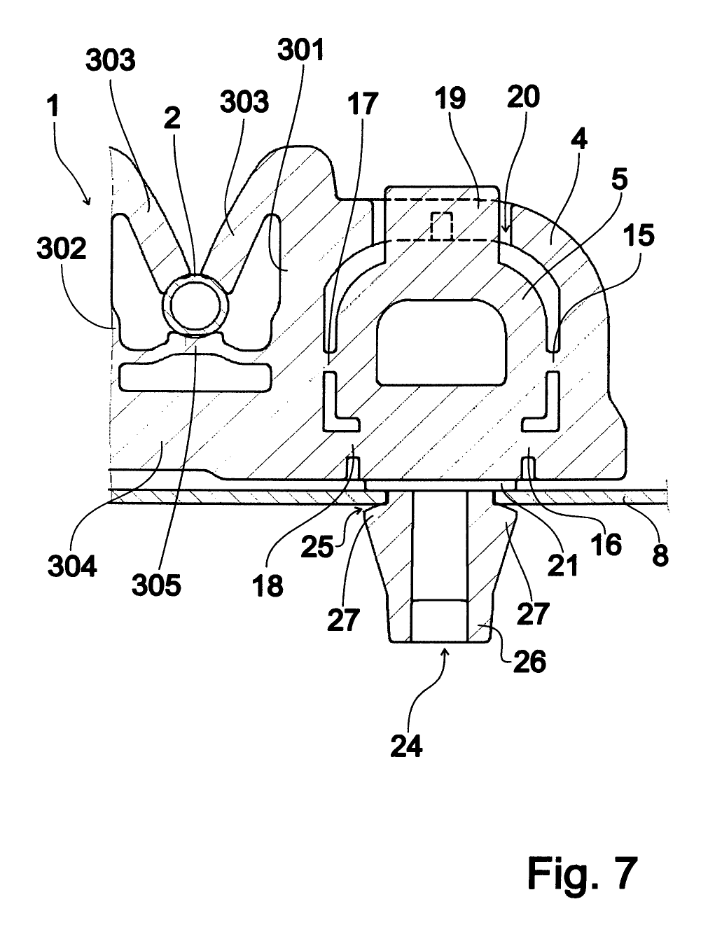

FIG. 7 is a sectional view of a further exemplary embodiment of a device according to the invention comprising a fastening arrangement formed by a snap-in foot 24; elements that are similar in the exemplary embodiment according to FIGS. 1 to 6 and in the exemplary embodiment according to FIG. 7 are provided with the same respective reference numerals and will not be described further below. The snap-in foot 24 is connected to inner cage 5 and extends away from inner cage 5; in the arrangement according to FIG. 7, it engages penetratingly through a snap recess 25 formed in carrier element 8.

In this exemplary embodiment, snap-in foot 24 has an elongated, substantially hollow-cylindrical foot shaft 26 on which are formed radially outwardly directed reverse-detention projections 27, which to secure the inventive device on carrier element 8 engage behind the rim of snap-in recess 25 on the side facing away from inner cage 5. Analogously to the previously described exemplary embodiment, this results in effective vibrational decoupling between holding element 1 and carrier element 8.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A device for fastening at least one object (2) to a support element (8), comprising an engaging arrangement (6) that can be brought into engagement with a fastening bolt (7) and, surrounding said engaging arrangement (6), an outer cage (4), characterized in that said engaging arrangement (6) is mounted on an inner cage (5) that is disposed inside said outer cage (4), and in that said inner cage (5) is connected to said outer cage (4) via a number of straight linking parts (15, 16, 17, 18, 22, 23).

2. A device for fastening at least one object (2) to a support element (8), comprising a fastening arrangement (24) by means of which a connection to said support element (8) can be realized, and comprising an outer cage (4) that stands connected to said fastening arrangement (24), characterized in that said fastening arrangement (24) is connected to an inner cage (5) that is disposed inside said outer cage (4), and in that said inner cage (5) is connected to said outer cage (4) via a number of straight linking parts (15, 16, 17, 18, 22, 23).

3. The device as in claim 1 or claim 2, characterized in that at least four linking parts (15, 16, 17, 18, 22, 23) are present, each set of two said linking parts (15, 16, 17, 18, 22, 23) being arranged as a pair on a respective connecting line and their connecting lines being arranged with each pair at right angles to the other.

4. The device as in claim 3, characterized in that said inner cage (5) comprises a neck portion (19) that extends through a neck opening (20) configured in said outer cage (4), and in that said neck portion (19) is connected to said outer cage (4) via mutually opposite linking parts (22, 23).

5. The device as in claim 4, characterized in that the connecting line on which the said linking parts (22, 23) connecting said neck portion (19) to said outer cage (4) lie is parallel to a connecting line on which a further pair of said linking parts (15, 16, 17, 18) lies.

6. The device as in claim 1 and one of claims 3 to 5, characterized in that said engaging arrangement (6) comprises a number of bolt claws (9, 10) that are able to be brought into engagement with said fastening bolt (7) and are connected to said inner cage (5) via linking ribs (11, 12, 13, 14).

7. The device as in claim 6, characterized in that said linking ribs (11, 12, 13, 14) are arranged endwise of said bolt claws (9, 10).

8. The device as in one of claims 2 to 5, characterized in that said fastening arrangement is formed by a snap-in foot (24) that can be snap-fit into a snap recess (25) configured in said support element (8).

9. The device as in one of claims 1 to 8, characterized in that said inner cage (5) protrudes by a cage support (21) beyond said outer cage (4) on the side located forwardly in the insertion direction.

10. The device as in one of claims 1 to 9, characterized in that that is it made from a foamed synthetic material.

11. The device as in claim 10, characterized in that said synthetic material is a PP/EPDM copolymer.
